(19) United States
(12) Patent Application Publication
(10) Pub. No.: US 2025/0257472 A1
(43) Pub. Date: Aug. 14, 2025

(54) CORROSION INHIBITOR COMPOSITIONS AND METHODS OF USING THE COMPOSITIONS TO INHIBIT CORROSION

(71) Applicant: ChampionX LLC, Sugar Land, TX (US)

(72) Inventor: Jeremy MOLONEY, Katy, TX (US)

(73) Assignee: ChampionX LLC, Sugar Land, TX (US)

(21) Appl. No.: 19/049,610

(22) Filed: Feb. 10, 2025

Related U.S. Application Data
(60) Provisional application No. 63/552,794, filed on Feb. 13, 2024.

(51) Int. Cl. C23F 11/16

(52) U.S. Cl. CPC C23F 11/161

(57) ABSTRACT

Compositions and methods for inhibiting corrosion of metal surfaces are disclosed herein. Also disclosed are methods of manufacturing the corrosion inhibitor compositions. A corrosion inhibitor composition may include an ether diamine compound. A corrosion inhibitor composition may include a sulfur-containing compound. A corrosion inhibitor composition may include an additional component and optionally a solvent.

### TECHNICAL FIELD

The present disclosure generally relates to methods and compositions useful for inhibiting corrosion of metallic surfaces.

### BACKGROUND

Aqueous liquids are injected into the earth and/or recovered from the earth during subterranean hydrocarbon recovery processes, such as hydraulic fracturing (fracking) and tertiary oil recovery. In some processes, an aqueous liquid called an “injectate” is injected into a subterranean formation and a water source called “produced water” is recovered, i.e., flows back from the subterranean formation and is collected along with a hydrocarbon product. The injectate and the produced water may include one or more corrodents, such as salts and/or other dissolved solids, liquids, or gases that cause, accelerate, or promote corrosion of metal surfaces and/or containments, such as metal pipelines and metal tanks.

Corrosion inhibitors are typically employed to reduce corrosion of metal surfaces that are contacted by liquids containing corrodents. Corrosion inhibitors are added to the liquids and dissolved gasses that come into contact with the metal surfaces and they act to prevent, retard, delay, reverse, and/or otherwise inhibit corrosion of the metal surfaces.

Typically, corrosion inhibitor compositions contain a variety of aliphatic organic surfactant molecules including, but not limited to, amines, quaternary amines, imidazolines, phosphate esters, amides, carboxylic acids, or combinations thereof.

Sulfur-containing compounds are also present in various corrosion inhibitor compositions. However, some sulfur-based corrosion inhibitors are known to produce hydrogen sulfide gas when stored in an enclosed space. Hydrogen sulfide is a known corrodent recognized to cause severe corrosion issues. Hydrogen sulfide is toxic and dissolves in both hydrocarbon (oil/gasoline) and water streams. Further, hydrogen sulfide is a flammable gas, providing a severe health and safety risk.

### BRIEF SUMMARY

The present disclosure provides compositions and methods for inhibiting corrosion of metal surfaces. In some embodiments, the disclosure provides a method of inhibiting corrosion of a metal surface in contact with a medium. The method comprises adding an effective amount of an ether diamine compound to the medium, and adding an effective amount of a sulfur-containing compound to the medium.

In some embodiments, a corrosion inhibitor composition of the present disclosure comprises an ether diamine compound and a sulfur-containing compound.

The present disclosure also provides a method of storing a corrosion inhibitor including a sulfur-containing compound. The method comprises combining the sulfur-containing compound with an ether diamine compound to form a stabilized corrosion inhibitor composition, wherein the weight ratio of the sulfur-containing compound to the ether diamine compound is about 1000:1 to about 1:1000. The method also includes storing the stabilized corrosion inhibitor composition in a substantially enclosed container for a period of time, wherein substantially no H₂S is formed within the container during the storing.

The foregoing has outlined rather broadly the features and technical advantages of the present disclosure in order that the detailed description that follows may be better understood. Additional features and advantages of the disclosure will be described hereinafter that form the subject of the claims of this application. It should be appreciated by those skilled in the art that the conception and the specific embodiments disclosed may be readily utilized as a basis for modifying or designing other embodiments for carrying out the same purposes of the present disclosure. It should also be realized by those skilled in the art that such equivalent embodiments do not depart from the spirit and scope of the disclosure as set forth in the appended claims.

### DETAILED DESCRIPTION

The present disclosure provides compositions and methods for inhibiting corrosion of metallic surfaces. The disclosure also provides methods of manufacturing the corrosion inhibitor compositions.

Unless otherwise indicated, an alkyl group as described herein—alone or as part of another group—is an optionally substituted linear or branched saturated monovalent hydrocarbon substituent containing from, for example, one to about sixty carbon atoms, such as one to about thirty carbon atoms, in the main chain. Examples of unsubstituted alkyl groups include methyl, ethyl, n-propyl, i-propyl, n-butyl, i-butyl, s-butyl, t-butyl, n-pentyl, i-pentyl, s-pentyl, t-pentyl, and the like.

The terms “aryl” or “ar” as used herein alone or as part of another group (e.g., arylene) denote optionally substituted homocyclic aromatic groups, such as monocyclic or bicyclic groups containing from about 6 to about 12 carbons in the ring portion, such as phenyl, biphenyl, naphthyl, substituted phenyl, substituted biphenyl or substituted naphthyl. The term “aryl” also includes heteroaryl functional groups. It is understood that the term “aryl” applies to cyclic substituents that are planar and comprise 4n+2 electrons, according to Huckel's Rule.

“Cycloalkyl” refers to a cyclic alkyl substituent containing from, for example, about 3 to about 8 carbon atoms, preferably from about 4 to about 7 carbon atoms, and more preferably from about 4 to about 6 carbon atoms. Examples of such substituents include cyclopropyl, cyclobutyl, cyclopentyl, cyclohexyl, cycloheptyl, cyclooctyl, and the like. The cyclic alkyl groups may be unsubstituted or further substituted with alkyl groups, such as methyl groups, ethyl groups, and the like.

“Halogen” or “halo” refers to F, Cl, Br, and I.

“Heteroaryl” refers to a monocyclic or bicyclic 5- or 6-membered ring system, wherein the heteroaryl group is unsaturated and satisfies Huckel's rule. Non-limiting examples of heteroaryl groups include furanyl, thiophenyl, pyrrolyl, pyrazolyl, imidazolyl, 1,2,3-triazolyl, 1,2,4-triazolyl, isoxazolyl, oxazolyl, isothiazolyl, thiazolyl, 1,3,4-oxadiazol-2-yl, 1,2,4-oxadiazol-2-yl, 5-methyl-1,3,4-oxadiazole, 3-methyl-1,2,4-oxadiazole, pyridinyl, pyrimidinyl, pyrazinyl, triazinyl, benzofuranyl, benzothiophenyl, indolyl, quinolinyl, isoquinolinyl, benzimidazolyl, benzoxazolinyl, benzothiazolinyl, quinazolinyl, and the like.

“Oxo” refers to an oxygen atom double-bonded to a carbon atom.

Compounds of the present disclosure may be substituted with suitable substituents. The term “suitable substituent,” as used herein, is intended to mean a chemically acceptable functional group, preferably a moiety that does not negate the activity of the compounds. Such suitable substituents include, but are not limited to, halo groups, perfluoroalkyl groups, perfluoro-alkoxy groups, alkyl groups, alkenyl groups, alkynyl groups, hydroxy groups, oxo groups, mercapto groups, alkylthio groups, alkoxy groups, aryl or heteroaryl groups, aryloxy or heteroaryloxy groups, aralkyl or heteroaralkyl groups, aralkoxy or heteroaralkoxy groups, HO—(C═O)— groups, heterocylic groups, cycloalkyl groups, amino groups, alkyl- and dialkylamino groups, carbamoyl groups, alkylcarbonyl groups, alkoxycarbonyl groups, alkylaminocarbonyl groups, dialkylamino carbonyl groups, arylcarbonyl groups, aryloxy-carbonyl groups, alkylsulfonyl groups, and arylsulfonyl groups. In some embodiments, suitable substituents may include halogen, an unsubstituted C₁-C₁₂ alkyl group, an unsubstituted C₄-C₆ aryl group, or an unsubstituted C₁-C₁₀ alkoxy group. Those skilled in the art will appreciate that many substituents can be substituted by additional substituents.

The term “substituted” as in “substituted alkyl,” means that in the group in question (i.e., the alkyl group), at least one hydrogen atom bound to a carbon atom is replaced with one or more substituent groups, such as hydroxy (—OH), alkylthio, phosphino, amido (—CON(R_{A})(R_{B}), wherein R_{A} and R_{B} are independently hydrogen, alkyl, or aryl), amino(—N(R_{A})(R_{B}), wherein R_{A} and R_{B} are independently hydrogen, alkyl, or aryl), halo (fluoro, chloro, bromo, or iodo), silyl, nitro (—NO₂), an ether (—OR_{A} wherein R_{A} is alkyl or aryl), an ester (—OC(O)R_{A} wherein R_{A} is alkyl or aryl), keto (—C(O)R_{A} wherein R_{A} is alkyl or aryl), heterocyclo, and the like.

When the term “substituted” introduces a list of possible substituted groups, it is intended that the term apply to every member of that group. That is, the phrase “optionally substituted alkyl or aryl” is to be interpreted as “optionally substituted alkyl or optionally substituted aryl.”

The terms “polymer,” “copolymer,” “polymerize,” “copolymerize,” and the like include not only polymers comprising two monomer residues and polymerization of two different monomers together, but also include (co)polymers comprising more than two monomer residues and polymerizing together more than two or more other monomers. For example, a polymer as disclosed herein includes a terpolymer, a tetrapolymer, polymers comprising more than four different monomers, as well as polymers comprising, consisting of, or consisting essentially of two different monomer residues. Additionally, a “polymer” as disclosed herein may also include a homopolymer, which is a polymer comprising a single type of monomer unit.

Unless specified differently, the polymers of the present disclosure may be linear, branched, crosslinked, structured, synthetic, semi-synthetic, natural, and/or functionally modified. A polymer of the present disclosure can be in the form of a solution, a dry powder, a liquid, or a dispersion, for example.

The compositions disclosed herein comprise, consist of, or consist essentially of an ether diamine compound. Any compound comprising at least one ether group and two amine groups may be incorporated into a composition of the present disclosure. For example, in some embodiments, the ether diamine compound comprises the following formula I:

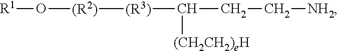

wherein e is 0 or 1;
R¹ is a C₃ to C₂₂ alkyl group;
R² is —(CH₂CH₂O)ₐ—(CH₂CH(CH₃)O)_{b}—(CH₂CH(CH₂CH₃)O)_{c}—;
a, b, and c are independently selected from an integer ranging from 0 to about 30; and
R³ is

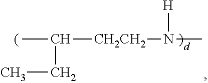

wherein d is 1.

The R¹ variable may be selected from, for example, a C₃ to C₂₀ alkyl group, a C₃ to C₁₈ alkyl group, a C₃ to C₁₆ alkyl group, a C₃ to C₁₄ alkyl group, a C₃ to C₁₂ alkyl group, a C₃ to C₁₀ alkyl group, a C₃ to C₈ alkyl group, a C₃ to C₆ alkyl group, a C₅ to C₂₂ alkyl group, a C₇ to C₂₂ alkyl group, a C₉ to C₂₂ alkyl group, a C₁₁ to C₂₂ alkyl group, a C₁₃ to C₂₂ alkyl group, a C₁₅ to C₂₂ alkyl group, a C₁₇ to C₂₂ alkyl group, a C₁₉ to C₂₂ alkyl group, a C₅ to C₁₂ alkyl group, a C₈ to C₁₅ alkyl group, a C₄ alkyl group, a C₆ alkyl group, a C₈ alkyl group, a C₁₀ alkyl group, a C₁₂ alkyl group, a C₁₄ alkyl group, a C₁₆ alkyl group, a C₁₈ alkyl group, or a C₂₀ alkyl group.

The a, b, and c variables may be independently selected from, for example, about 2 to about 30, about 4 to about 30, about 6 to about 30, about 8 to about 30, about 10 to about 30, about 15 to about 30, about 20 to about 30, about 25 to about 30, about 2 to about 25, about 2 to about 20, about 2 to about 15, about 2 to about 10, about 2 to about 8, about 2 to about 6, about 2 to about 4, about 2, about 3, about 4, about 5, about 6, about 7, about 8, about 9, about 10, about 11, about 12, about 13, about 14, about 15, about 16, about 17, about 18, about 19, about 20, about 21, about 22, about 23, about 24, about 25, about 26, about 27, about 28, or about 29.

In some embodiments, the ether diamine compound comprises the following formula II:

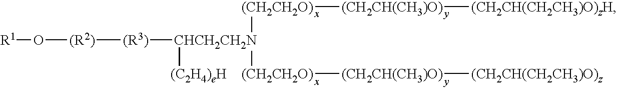

wherein R¹ is a C₃ to C₂₂ alkyl group or a C₆ to C₂₀ aryl group;
R² is —(CH₂CH₂O)ₐ—(CH₂CH(CH₃)O)_{b}—(CH₂CH(CH₂CH₃)O)_{c}—;
a, b, and c are independently selected from an integer ranging from 0 to about 30, with the proviso that a+b+c is from 0 to about 60; and
R³ is

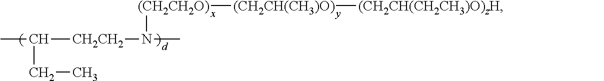

wherein d is 1, e is 0 or 1, and x, y, and z are independently selected from an integer ranging from 0 to about 30 with the proviso that x+y+x is at least 2 but not greater than 60.

The R¹ variable may be selected from, for example, a C₃ to C₂₀ alkyl group, a C₃ to C₁₈ alkyl group, a C₃ to C₁₆ alkyl group, a C₃ to C₁₄ alkyl group, a C₃ to C₁₂ alkyl group, a C₃ to C₁₀alkyl group, a C₃ to C₈ alkyl group, a C₃ to C₆ alkyl group, a C₅ to C₂₂ alkyl group, a C₇ to C₂₂ alkyl group, a C₉ to C₂₂ alkyl group, a C₁₁ to C₂₂ alkyl group, a C₁₃ to C₂₂ alkyl group, a C₁₅ to C₂₂ alkyl group, a C₁₇ to C₂₂ alkyl group, a C₁₉ to C₂₂ alkyl group, a C₅ to C₁₂ alkyl group, a C₈ to C₁₅ alkyl group, a C₄ alkyl group, a C₆ alkyl group, a C₈ alkyl group, a C₁₀alkyl group, a C₁₂ alkyl group, a C₁₄ alkyl group, a C₁₆ alkyl group, a C₁₈ alkyl group, or a C₂₀ alkyl group.

The R¹ variable may also be selected from, for example, a C₆ to C₁₈ aryl group, a C₆ to C₁₆ aryl group, a C₆ to C₁₄ aryl group, a C₆ to C₁₂ aryl group, a C₆ to C₁₀ aryl group, a C₆ to C₈ aryl group, a C₈ to C₁₈ aryl group, a C₁ to C₁₈ aryl group, a C₁₂ to C₁₈ aryl group, a C₁₄ to C₁₈ aryl group, or a C₁₆ to C₁₈ aryl group.

The a, b, and c variables may be independently selected from, for example, about 2 to about 30, about 4 to about 30, about 6 to about 30, about 8 to about 30, about 10 to about 30, about 15 to about 30, about 20 to about 30, about 25 to about 30, about 2 to about 25, about 2 to about 20, about 2 to about 15, about 2 to about 10, about 2 to about 8, about 2 to about 6, about 2 to about 4, about 2, about 3, about 4, about 5, about 6, about 7, about 8, about 9, about 10, about 11, about 12, about 13, about 14, about 15, about 16, about 17, about 18, about 19, about 20, about 21, about 22, about 23, about 24, about 25, about 26, about 27, about 28, or about 29.

The x, y, and z variables may be independently selected from, for example, about 2 to about 30, about 4 to about 30, about 6 to about 30, about 8 to about 30, about 10 to about 30, about 15 to about 30, about 20 to about 30, about 25 to about 30, about 2 to about 25, about 2 to about 20, about 2 to about 15, about 2 to about 10, about 2 to about 8, about 2 to about 6, about 2 to about 4, about 2, about 3, about 4, about 5, about 6, about 7, about 8, about 9, about 10, about 11, about 12, about 13, about 14, about 15, about 16, about 17, about 18, about 19, about 20, about 21, about 22, about 23, about 24, about 25, about 26, about 27, about 28, or about 29.

In some embodiments, the ether diamine compound comprises the following formula III:

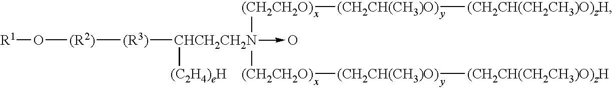

wherein R¹ is a C₃ to C₂₂ alkyl group or a C₆ to C₂₀ aryl group;
R² is —(CH₂CH₂O)ₐ—(CH₂CH(CH₃)O)_{b}—(CH₂CH(CH₂CH₃)O)_{c}—;
a, b, and c are independently selected from an integer ranging from 0 to about 30, with the proviso that a+b+c is from 0 to about 60; and
R³ is

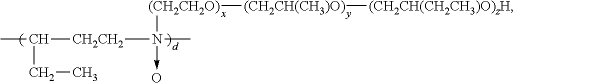

wherein d is 1, e is 0 or 1, and x, y, and z are independently selected from an integer ranging from 0 to about 30 with the proviso that x+y+x is at least 2 but not greater than 60.

The R¹ variable may be selected from, for example, a C₃ to C₂₀ alkyl group, a C₃ to C₁₈ alkyl group, a C₃ to C₁₆ alkyl group, a C₃ to C₁₄ alkyl group, a C₃ to C₁₂ alkyl group, a C₃ to C₁₀ alkyl group, a C₃ to C₈ alkyl group, a C₃ to C₆ alkyl group, a C₅ to C₂₂ alkyl group, a C₇ to C₂₂ alkyl group, a C₉ to C₂₂ alkyl group, a C₁₁ to C₂₂ alkyl group, a C₁₃ to C₂₂ alkyl group, a C₁₅ to C₂₂ alkyl group, a C₁₇ to C₂₂ alkyl group, a C₁₉ to C₂₂ alkyl group, a C₅ to C₁₂ alkyl group, a C₈ to C₁₅ alkyl group, a C₄ alkyl group, a C₆ alkyl group, a C₈ alkyl group, a C₁₀ alkyl group, a C₁₂ alkyl group, a C₁₄ alkyl group, a C₁₆ alkyl group, a C₁₈ alkyl group, or a C₂₀ alkyl group.

The R¹ variable may also be selected from, for example, a C₆ to C₁₈ aryl group, a C₆ to C₁₆ aryl group, a C₆ to C₁₄ aryl group, a C₆ to C₁₂ aryl group, a C₆ to C₁₀ aryl group, a C₆ to C₈ aryl group, a C₈ to C₁₈ aryl group, a C₁₀ to C₁₈ aryl group, a C₁₂ to C₁₈ aryl group, a C₁₄ to C₁₈ aryl group, or a C₁₆ to C₁₈ aryl group.

The a, b, and c variables may be independently selected from, for example, about 2 to about 30, about 4 to about 30, about 6 to about 30, about 8 to about 30, about 10 to about 30, about 15 to about 30, about 20 to about 30, about 25 to about 30, about 2 to about 25, about 2 to about 20, about 2 to about 15, about 2 to about 10, about 2 to about 8, about 2 to about 6, about 2 to about 4, about 2, about 3, about 4, about 5, about 6, about 7, about 8, about 9, about 10, about 11, about 12, about 13, about 14, about 15, about 16, about 17, about 18, about 19, about 20, about 21, about 22, about 23, about 24, about 25, about 26, about 27, about 28, or about 29.

The x, y, and z variables may be independently selected from, for example, about 2 to about 30, about 4 to about 30, about 6 to about 30, about 8 to about 30, about 10 to about 30, about 15 to about 30, about 20 to about 30, about 25 to about 30, about 2 to about 25, about 2 to about 20, about 2 to about 15, about 2 to about 10, about 2 to about 8, about 2 to about 6, about 2 to about 4, about 2, about 3, about 4, about 5, about 6, about 7, about 8, about 9, about 10, about 11, about 12, about 13, about 14, about 15, about 16, about 17, about 18, about 19, about 20, about 21, about 22, about 23, about 24, about 25, about 26, about 27, about 28, or about 29.

In some embodiments, the ether diamine compound comprises the following formula IV:

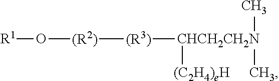

wherein R¹ is a C₃ to C₂₂ alkyl group or a C₆ to C₂₀ aryl group;
R² is —(CH₂CH₂O)ₐ—(CH₂CH(CH₃)O)_{b}—(CH₂CH(CH₂CH₃)O)_{c}—;
a, b, and c are independently selected from an integer ranging from 0 to about 30, with the proviso that a+b+c is from 0 to about 60; and
R³ is

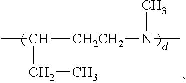

wherein d is 1, and e is 0 or 1.

The R¹ variable may be selected from, for example, a C₃ to C₂₀ alkyl group, a C₃ to C₁₈ alkyl group, a C₃ to C₁₆ alkyl group, a C₃ to C₁₄ alkyl group, a C₃ to C₁₂ alkyl group, a C₃ to C₁₀alkyl group, a C₃ to C₈ alkyl group, a C₃ to C₆ alkyl group, a C₅ to C₂₂ alkyl group, a C₇ to C₂₂ alkyl group, a C₉ to C₂₂ alkyl group, a C₁₁ to C₂₂ alkyl group, a C₁₃ to C₂₂ alkyl group, a C₁₅ to C₂₂ alkyl group, a C₁₇ to C₂₂ alkyl group, a C₁₉ to C₂₂ alkyl group, a C₅ to C₁₂ alkyl group, a C₈ to C₁₅ alkyl group, a C₄ alkyl group, a C₆ alkyl group, a C₈ alkyl group, a C₁₀ alkyl group, a C₁₂ alkyl group, a C₁₄ alkyl group, a C₁₆ alkyl group, a C₁₈ alkyl group, or a C₂₀ alkyl group.

The R¹ variable may also be selected from, for example, a C₆ to C₁₈ aryl group, a C₆ to C₁₆ aryl group, a C₆ to C₁₄ aryl group, a C₆ to C₁₂ aryl group, a C₆ to C₁₀ aryl group, a C₆ to C₈ aryl group, a C₈ to C₁₈ aryl group, a C₁₀ to C₁₈ aryl group, a C₁₂ to C₁₈ aryl group, a C₁₄ to C₁₈ aryl group, or a C₁₆ to C₁₈ aryl group.

The a, b, and c variables may be independently selected from, for example, about 2 to about 30, about 4 to about 30, about 6 to about 30, about 8 to about 30, about 10 to about 30, about 15 to about 30, about 20 to about 30, about 25 to about 30, about 2 to about 25, about 2 to about 20, about 2 to about 15, about 2 to about 10, about 2 to about 8, about 2 to about 6, about 2 to about 4, about 2, about 3, about 4, about 5, about 6, about 7, about 8, about 9, about 10, about 11, about 12, about 13, about 14, about 15, about 16, about 17, about 18, about 19, about 20, about 21, about 22, about 23, about 24, about 25, about 26, about 27, about 28, or about 29.

In some embodiments, the ether diamine compound comprises the following formula V:

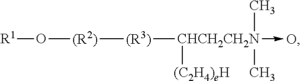

wherein R¹ is a C₃ to C₂₂ alkyl group or a C₆ to C₂₀ aryl group;
R² is —(CH₂CH₂O)ₐ—(CH₂CH(CH₃)O)_{b}—(CH₂CH(CH₂CH₃)O)_{c}—;
a, b, and c are independently selected from an integer ranging from 0 to about 30, with the proviso that a+b+c is from 0 to about 60; and
R³ is

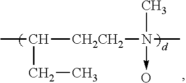

wherein d is 1 and e is 0 or 1.

The R¹ variable may be selected from, for example, a C₃ to C₂₀ alkyl group, a C₃ to C₁₈ alkyl group, a C₃ to C₁₆ alkyl group, a C₃ to C₁₄ alkyl group, a C₃ to C₁₂ alkyl group, a C₃ to C₁₀alkyl group, a C₃ to C₈ alkyl group, a C₃ to C₆ alkyl group, a C₅ to C₂₂ alkyl group, a C₇ to C₂₂ alkyl group, a C₉ to C₂₂ alkyl group, a C₁₁ to C₂₂ alkyl group, a C₁₃ to C₂₂ alkyl group, a C₁₅ to C₂₂ alkyl group, a C₁₇ to C₂₂ alkyl group, a C₁₉ to C₂₂ alkyl group, a C₅ to C₁₂ alkyl group, a C₈ to C₁₅ alkyl group, a C₄ alkyl group, a C₆ alkyl group, a C₈ alkyl group, a C₁₀alkyl group, a C₁₂ alkyl group, a C₁₄ alkyl group, a C₁₆ alkyl group, a C₁₈ alkyl group, or a C₂₀ alkyl group.

The R¹ variable may also be selected from, for example, a C₆ to C₁₈ aryl group, a C₆ to C₁₆ aryl group, a C₆ to C₁₄ aryl group, a C₆ to C₁₂ aryl group, a C₆ to C₁₀ aryl group, a C₆ to C₈ aryl group, a C₈ to C₁₈ aryl group, a C₁ to C₁₈ aryl group, a C₁₂ to C₁₈ aryl group, a C₁₄ to C₁₈ aryl group, or a C₁₆ to C₁₈ aryl group.

The a, b, and c variables may be independently selected from, for example, about 2 to about 30, about 4 to about 30, about 6 to about 30, about 8 to about 30, about 10 to about 30, about 15 to about 30, about 20 to about 30, about 25 to about 30, about 2 to about 25, about 2 to about 20, about 2 to about 15, about 2 to about 10, about 2 to about 8, about 2 to about 6, about 2 to about 4, about 2, about 3, about 4, about 5, about 6, about 7, about 8, about 9, about 10, about 11, about 12, about 13, about 14, about 15, about 16, about 17, about 18, about 19, about 20, about 21, about 22, about 23, about 24, about 25, about 26, about 27, about 28, or about 29.

In some embodiments, the ether diamine compound comprises the following formula VI:

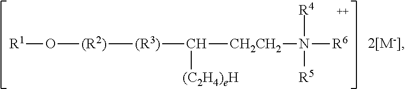

wherein R¹ is a C₃ to C₂₂ alkyl group;
R² is —(CH₂CH₂O)ₐ—(CH₂CH(CH₃)O)_{b}—(CH₂CH(CH₂CH₃)O)_{c}—;
a, b, and c are independently selected from an integer ranging from 0 to about 30;
R³ is

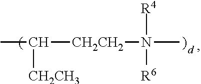

wherein d is 1 and e is 0 or 1;
R⁴ and R⁵ are independently selected from —CH₃ and —(CH₂CH₂O)ₓ—(CH₂CH(CH₃)O)_{y}—(CH₂CH(CH₂CH₃)O)_{z}H;
x, y, and z are independently selected from integers ranging from 0 to about 20, with the proviso that x+y+z is greater than or equal to 3;
R⁶ is selected from —CH₃ or —CH₂—C₆H₅; and
M is an anion.

The R¹ variable may be selected from, for example, a C₃ to C₂₀ alkyl group, a C₃ to C₁₈ alkyl group, a C₃ to C₁₆ alkyl group, a C₃ to C₁₄ alkyl group, a C₃ to C₁₂ alkyl group, a C₃ to C₁₀alkyl group, a C₃ to C₈ alkyl group, a C₃ to C₆ alkyl group, a C₅ to C₂₂ alkyl group, a C₇ to C₂₂ alkyl group, a C₉ to C₂₂ alkyl group, a C₁₁ to C₂₂ alkyl group, a C₁₃ to C₂₂ alkyl group, a C₁₅ to C₂₂ alkyl group, a C₁₇ to C₂₂ alkyl group, a C₁₉ to C₂₂ alkyl group, a C₅ to C₁₂ alkyl group, a C₈ to C₁₅ alkyl group, a C₄ alkyl group, a C₆ alkyl group, a C₈ alkyl group, a C₁₀alkyl group, a C₁₂ alkyl group, a C₁₄ alkyl group, a C₁₆ alkyl group, a C₁₈ alkyl group, or a C₂₀ alkyl group.

The a, b, and c variables may be independently selected from, for example, about 2 to about 30, about 4 to about 30, about 6 to about 30, about 8 to about 30, about 10 to about 30, about 15 to about 30, about 20 to about 30, about 25 to about 30, about 2 to about 25, about 2 to about 20, about 2 to about 15, about 2 to about 10, about 2 to about 8, about 2 to about 6, about 2 to about 4, about 2, about 3, about 4, about 5, about 6, about 7, about 8, about 9, about 10, about 11, about 12, about 13, about 14, about 15, about 16, about 17, about 18, about 19, about 20, about 21, about 22, about 23, about 24, about 25, about 26, about 27, about 28, or about 29.

The x, y, and z variables may be independently selected from, for example, about 2 to about 30, about 4 to about 30, about 6 to about 30, about 8 to about 30, about 10 to about 30, about 15 to about 30, about 20 to about 30, about 25 to about 30, about 2 to about 25, about 2 to about 20, about 2 to about 15, about 2 to about 10, about 2 to about 8, about 2 to about 6, about 2 to about 4, about 2, about 3, about 4, about 5, about 6, about 7, about 8, about 9, about 10, about 11, about 12, about 13, about 14, about 15, about 16, about 17, about 18, about 19, about 20, about 21, about 22, about 23, about 24, about 25, about 26, about 27, about 28, or about 29.

The M anion may comprise, for example, chloride, fluoride, bromide, nitrate, nitrite, sulfate, phosphate, hydride, oxide, hydroxide, and/or sulfide.

In still further embodiments, the ether diamine compound comprises 4,7,10-trioxa-1,13-tridecanediamine, polyetheramine, bis(2-aminoethyl) ether, tetramethyldiaminoether, ethylene glycol bis(3-aminopropyl) ether, or any combination thereof.

The compositions disclosed herein may comprise, consist of, or consist essentially of a single ether diamine compound or any number of ether diamine compounds, with one or more sulfur-containing compounds and optionally a solvent.

The sulfur-containing compound may be selected from the group consisting of mercaptoethanol, sodium thiosulfate, thioglycolic acid, and any combination thereof. Illustrative, non-limiting examples include 2-mercaptoethanol (thioglycol), thioglycolic acid (mercaptoacetic acid), methylthioglycolate, 4-mercaptophenol, 4-methoxybenzenthiol, and disodium thiosulfate (sodium thiosulfate).

The sulfur-containing compound may be added before and/or after and/or with the ether diamine compound. In some embodiments, a composition comprising, consisting of, or consisting essentially of the ether diamine compound and optionally a solvent is added before and/or after a composition comprising, consisting of, or consisting essentially of a sulfur-containing compound and optionally a solvent. In certain embodiments, a composition may comprise, consist of, or consist essentially of an ether diamine compound, a sulfur-containing compound, and optionally a solvent. Alternatively, a first composition may comprise, consist of, or consist essentially of the ether diamine compound and a second composition may comprise, consist of, or consist essentially of the sulfur-containing compound.

In certain embodiments, the compositions disclosed herein comprise one or more solvents. For example, a composition in accordance with the present disclosure may comprise a solvent selected from water, a C₁-C₆ alkanol, a C₁-C₆ alkoxyalkanol, an alcohol, a glycol ether, a hydrocarbon, a ketone, an ether, an aromatic, an alkylene glycol, an amide, a nitrile, a sulfoxide, an ester, and any combination thereof.

In some embodiments, a composition of the present disclosure may be in the form of a liquid, a gel, or a mixture thereof.

In certain embodiments, the compositions disclosed herein comprise a pH from about 1 to about 14. In some embodiments, the pH of the composition may be from about 1 to about 12, from about 1 to about 10, from about 1 to about 9, from about 1 to about 8, from about 1 to about 7, from about 1 to about 6, from about 1 to about 5, from about 3 to about 14, from about 5 to about 14, from about 6 to about 14, from about 7 to about 14, from about 8 to about 14, from about 9 to about 14, from about 11 to about 14, from about 5 to about 11, from about 3 to about 8, from about 6 to about 9, or from about 6 to about 8, such as about 7. In some embodiments, the medium contacting the metal surface may have any of the foregoing pH ranges or values.

A composition of the present disclosure may include any amount of the ether diamine compound. For example, the composition may comprise from about 0.5 wt. % to about 100 wt. % of the reaction product, such as from about 0.5 wt. % to about 90 wt. %, about 0.5 wt. % to about 80 wt. %, about 0.5 wt. % to about 70 wt. %, about 0.5 wt. % to about 60 wt. %, about 0.5 wt. % to about 50 wt. %, about 0.5 wt. % to about 40 wt. %, about 0.5 wt. % to about 30 wt. %, about 0.5 wt. % to about 20 wt. %, about 0.5 wt. % to about 15 wt. %, about 0.5 wt. % to about 10 wt. %, or about 0.5 wt. % to about 5 wt. % of the ether diamine compound.

A composition of the present disclosure may include any amount of the sulfur-containing compound. For example, the composition may comprise from about 0.5 wt. % to about 100 wt. % of the reaction product, such as from about 0.5 wt. % to about 90 wt. %, about 0.5 wt. % to about 80 wt. %, about 0.5 wt. % to about 70 wt. %, about 0.5 wt. % to about 60 wt. %, about 0.5 wt. % to about 50 wt. %, about 0.5 wt. % to about 40 wt. %, about 0.5 wt. % to about 30 wt. %, about 0.5 wt. % to about 20 wt. %, about 0.5 wt. % to about 15 wt. %, about 0.5 wt. % to about 10 wt. %, or about 0.5 wt. % to about 5 wt. % of the sulfur-containing compound.

The present disclosure also provides methods of inhibiting corrosion of a metal surface in contact with a medium. The methods comprise adding an effective amount of an ether diamine compound and a sulfur-containing compound to the medium, optionally wherein a solvent comprises the ether diamine compound and/or the sulfur-containing compound. The ether diamine compound and/or the sulfur-containing compound may be added continuously, intermittently, automatically, and/or manually.

In some embodiments, the effective amount of the ether diamine compound added to the medium is from about 1 ppm to about 50,000 ppm. For example, the effective amount may be from about 1 ppm to about 45,000 ppm, from about 1 ppm to about 40,000 ppm, from about 1 ppm to about 35,000 ppm, from about 1 ppm to about 30,000 ppm, from about 1 ppm to about 25,000 ppm, from about 1 ppm to about 20,000 ppm, from about 1 ppm to about 15,000 ppm, from about 1 ppm to about 10,000 ppm, from about 1 ppm to about 5,000 ppm, from about 1 ppm to about 3,000 ppm, from about 1 ppm to about 2,000 ppm, from about 1 ppm to about 1,000 ppm, from about 1 ppm to about 750 ppm, from about 1 ppm to about 500 ppm, from about 100 ppm to about 800 ppm, from about 100 ppm to about 600 ppm, or from about 200 ppm to about 500 ppm.

In some embodiments, the effective amount of the sulfur-containing compound added to the medium is from about 1 ppm to about 50,000 ppm. For example, the effective amount may be from about 1 ppm to about 45,000 ppm, from about 1 ppm to about 40,000 ppm, from about 1 ppm to about 35,000 ppm, from about 1 ppm to about 30,000 ppm, from about 1 ppm to about 25,000 ppm, from about 1 ppm to about 20,000 ppm, from about 1 ppm to about 15,000 ppm, from about 1 ppm to about 10,000 ppm, from about 1 ppm to about 5,000 ppm, from about 1 ppm to about 3,000 ppm, from about 1 ppm to about 2,000 ppm, from about 1 ppm to about 1,000 ppm, from about 1 ppm to about 750 ppm, from about 1 ppm to about 500 ppm, from about 100 ppm to about 800 ppm, from about 100 ppm to about 600 ppm, or from about 200 ppm to about 500 ppm.

In some embodiments, the medium comprises an aqueous medium, such as produced water, seawater, fresh water, recycled water, salt water, surface water, condensed water, cooling water, injection water, wastewater, geothermal waters, sewage water, nuclear cooling water, or any mixture thereof. The aqueous medium may be a continuously flowing medium, such as produced water flowing from a subterranean reservoir and into or through a pipe or tank. The aqueous medium may also be, for example, wastewater isolated from a continuous manufacturing process flowing into a wastewater treatment apparatus. In other embodiments, the aqueous medium is a batch, or plug, substantially disposed in a batchwise or static state within a metal containment.

The presently disclosed compositions are useful for inhibiting corrosion of metal surfaces in contact with any type of corrodent in the medium, such as metal cations, metal complexes, metal chelates, organometallic complexes, aluminum ions, ammonium ions, barium ions, chromium ions, cobalt ions, cuprous ions, cupric ions, calcium ions, ferrous ions, ferric ions, hydrogen ions, magnesium ions, manganese ions, molybdenum ions, nickel ions, potassium ions, sodium ions, strontium ions, titanium ions, uranium ions, vanadium ions, zinc ions, bromide ions, carbonate ions, chlorate ions, chloride ions, chlorite ions, dithionate ions, fluoride ions, hypochlorite ions, iodide ions, nitrate ions, nitrite ions, oxide ions, perchlorate ions, peroxide ions, phosphate ions, phosphite ions, sulfate ions, sulfide ions, sulfite ions, hydrogen carbonate ions, hydrogen phosphate ions, hydrogen phosphite ions, hydrogen sulfate ions, hydrogen sulfite ions, an acid, such as carbonic acid, hydrochloric acid, nitric acid, sulfuric acid, nitrous acid, sulfurous acid, a peroxy acid, or phosphoric acid, ammonia, bromine, carbon dioxide, chlorine, chlorine dioxide, fluorine, hydrogen chloride, hydrogen sulfide, iodine, nitrogen dioxide, nitrogen monoxide, oxygen, ozone, sulfur dioxide, hydrogen peroxide, polysaccharides, metal oxides, sands, clays, silicon dioxide, titanium dioxide, muds, insoluble inorganic and/or organic particulates, an oxidizing agent, a chelating agent, an alcohol, and any combination of the foregoing.

In particular embodiments, the medium comprises a corrodent selected from the group consisting of hydrogen sulfide, carbon dioxide, oxygen, sodium chloride, calcium chloride, sulfur dioxide, elemental sulfur, organic acids, and any combination thereof.

In some embodiments, the medium is an aqueous medium with a pH of about 1 to about 14. For example, the aqueous medium may have a pH less than about 7 or greater than about 7. In some embodiments, the pH of the aqueous medium is between about 1 and about 6, about 2 and about 6, about 3 and about 6, about 4 and about 6, and about 5 and about 6. In some embodiments, the pH of the aqueous medium is between about 7 and about 14. For example, the pH may be about 7 to about 12, about 7 to about 10, or about 7 to about 8. Additionally, the pH may be about 4 to about 11, about 5 to about 10, about 6 to about 9, or about 7 to about 8.

In some embodiments, the aqueous medium comprises from about 1 ppm to about 50,000 ppm, by weight or by volume, of the ether diamine compound. In some embodiments, the aqueous medium comprises from about 1 ppm to about 40,000 ppm, from about 1 ppm to about 30,000 ppm, from about 1 ppm to about 20,000 ppm, from about 1 ppm to about 10,000 ppm, from about 1 ppm to about 5,000 ppm, from about 1 ppm to about 1,000 ppm, from about 1 ppm to about 500 ppm, or from about 1 ppm to about 100 ppm of the ether diamine compound.

In some embodiments, the aqueous medium comprises from about 1 ppm to about 50,000 ppm, by weight or by volume, of the sulfur-containing compound. In some embodiments, the aqueous medium comprises from about 1 ppm to about 40,000 ppm, from about 1 ppm to about 30,000 ppm, from about 1 ppm to about 20,000 ppm, from about 1 ppm to about 10,000 ppm, from about 1 ppm to about 5,000 ppm, from about 1 ppm to about 1,000 ppm, from about 1 ppm to about 500 ppm, or from about 1 ppm to about 100 ppm of the ether diamine compound.

The presently disclosed compositions are useful for inhibiting corrosion of any metal surfaces. In some embodiments, the metal surface comprises steel or a steel alloy, such as stainless steel, a stainless steel alloy, carbon steel, and/or a carbon steel alloy. The metal surface may comprise one or more of brass, copper, and zinc. In some embodiments, the metal surface comprises iron, aluminum, zinc, chromium, manganese, nickel, tungsten, molybdenum, titanium, vanadium, cobalt, niobium, or copper. The metal surface may also comprise any combination of the foregoing metals and/or any one or more of boron, phosphorus, sulfur, silicon, oxygen, and nitrogen. In some embodiments, a pipe or a tank (e.g., railroad tank car or a tank truck/tanker) comprises the metal surface.

In some embodiments, the methods disclosed herein further comprise adding an additional component to the medium. The additional component may be added before, after, and/or with the ether diamine compound and/or the sulfur-containing compound. The additional component may be added continuously, automatically, intermittently, and/or manually. In some embodiments, a composition disclosed herein comprises the additional component. In some embodiments, the composition consists of or consists essentially of the ether diamine compound and/or the sulfur-containing compound, the additional component, and optionally a solvent.

Illustrative, non-limiting examples of additional components include a fouling control agent, an additional corrosion inhibitor, a biocide, a preservative, an acid, a hydrogen sulfide scavenger, a surfactant, an asphaltene inhibitor, a paraffin inhibitor, a scale inhibitor, a gas hydrate inhibitor, a pH modifier, an emulsion breaker, a reverse emulsion breaker, a coagulant/flocculant agent, an emulsifier, a water clarifier, a dispersant, an antioxidant, a polymer degradation prevention agent, a permeability modifier, a foaming agent, an antifoaming agent, a CO₂ scavenger, an 02 scavenger, a gelling agent, a lubricant, a friction reducing agent, a salt, and any combination thereof.

The additional corrosion inhibitor may comprise, for example, an imidazoline compound, a pyridinium compound, a quaternary ammonium compound, a phosphate ester, an amine, an amide, a carboxylic acid, a thiol, and any combination thereof.

The fouling control agent may comprise, for example, a quaternary compound.

Illustrative, non-limiting examples of biocides include chlorine, hypochlorite, ClO₂, bromine, ozone, hydrogen peroxide, peracetic acid, peroxycarboxylic acid, peroxycarboxylic acid composition, peroxysulphate, glutaraldehyde, dibromonitrilopropionamide, isothiazolone, terbutylazine, polymeric biguanide, methylene bisthiocyanate, tetrakis hydroxymethyl phosphonium sulphate, and any combination thereof.

The acid may comprise, for example, hydrochloric acid, hydrofluoric acid, citric acid, formic acid, acetic acid, or any combination thereof.

The hydrogen sulfide scavenger may comprise, for example, an oxidant, inorganic peroxide, chlorine dioxide, a C₁-C₁₀ aldehyde, formaldehyde, glyoxal, glutaraldehyde, acrolein, methacrolein, a triazine, or any combination thereof.

The surfactant may be non-ionic, cationic, anionic, amphoteric, or zwitterionic.

When a composition comprises an additional component (or combination of components), it generally comprises from about 0.1 wt. % to about 40 wt. % of the additional component. For example, the composition may comprise from about 0.1 wt. % to about 25 wt. %, from about 0.1 wt. % to about 20 wt. %, from about 0.1 wt. % to about 15 wt. %, from about 0.1 wt. % to about 10 wt. %, from about 0.1 wt. % to about 5 wt. %, or from about 1 wt. % to about 10 wt. % of the additional component.

In some embodiments, the effective amount of the additional component added to the medium is from about 0.5 ppm to about 50,000 ppm. For example, the effective amount may be from about 0.5 ppm to about 45,000 ppm, from about 0.5 ppm to about 40,000 ppm, from about 0.5 ppm to about 35,000 ppm, from about 0.5 ppm to about 30,000 ppm, from about 0.5 ppm to about 25,000 ppm, from about 0.5 ppm to about 20,000 ppm, from about 0.5 ppm to about 15,000 ppm, from about 0.5 ppm to about 10,000 ppm, from about 0.5 ppm to about 5,000 ppm, from about 0.5 ppm to about 3,000 ppm, from about 0.5 ppm to about 2,000 ppm, from about 0.5 ppm to about 1,000 ppm, from about 0.5 ppm to about 750 ppm, from about 0.5 ppm to about 500 ppm, from about 100 ppm to about 800 ppm, from about 100 ppm to about 600 ppm, or from about 200 ppm to about 500 ppm.

The ether diamine compound, sulfur-containing compound, and/or additional component may be added to the medium neat, dissolved in a solvent, partially dissolved in a solvent, and/or dispersed in a solvent. The addition may involve manual addition, automatic addition, dripping, pouring, spraying, pumping, injecting, or otherwise adding the composition and optional component to the medium and/or the metal surface. In some embodiments, the compounds, compositions, additional components, etc., may be heated, such as from about 30° C. to 100° C., prior to addition. In some embodiments, a composition, compound, and/or additional component is added directly to the metal surface instead of or in addition to the medium.

In some embodiments, the medium and/or metal surface to be treated with the presently disclosed composition may be located in a cooling water system, a boiler water system, a petroleum well, a downhole formation, or a geothermal well. In certain embodiments, a pipeline, a flowline, a downhole tubular, a casing, a tank, and/or a separator comprises the metal surface.

The disclosure also provides methods of storing a corrosion inhibitor as disclosed herein including any of the sulfur-containing compounds disclosed herein. The method includes combining the sulfur-containing compound with any ether diamine compound disclosed herein to form a stabilized corrosion inhibitor composition. The method also comprises storing the stabilized corrosion inhibitor composition in a substantially enclosed container for a period of time, wherein substantially no H₂S is formed within the container during the storing.

Substantially no H₂S may be defined, for example, as about 100 ppm or less H₂S, such as about 1 ppm to about 80 ppm, about 1 ppm to about 60 ppm, about 1 ppm to about 40 ppm, about 1 ppm to about 20 ppm, about 1 ppm to about 10 ppm.

The weight ratio of the sulfur-containing compound to the ether diamine compound may be from about 1,000:1 to about 1:1,000, such as from about 800:1 to about 1:800, about 600:1 to about 1:600, from about 400:1 to about 1:400, from about 200:1 to about 1:200, from about 100:1 to about 1:100, from about 50:1 to about 1:50, from about 25:1 to about 1:25, from about 10:1 to about 1:10, from about 5:1 to about 1:5, or from about 2:1 to about 1:2.

The stabilized compositions may be stored within enclosed containers at temperatures of about 0° C. to 60° C., such as about 10° C. to about 50° C. or about 20° C. to 30° C. for a storage period of about 1 day to about 2 years, such as about 1 week to about 2 years, about 1 month to about 2 years, about 6 months to about 2 years, or about 1 year to about 2 years. During the storage, no special steps or treatments are required to stabilize or mitigate degradation within the stabilized compositions.

Containers useful for storing the stabilized concentrates are substantially enclosed, which means the container is substantially isolated from the atmosphere. Substantial isolation means that the container is isolated from the atmosphere during the storage period but may be periodically and temporarily opened during the storage period, for example, to remove an aliquot of the composition for application to a water source within a metal containment. It is a feature of the stabilized compositions of the present disclosure that no or substantially no H₂S is detectible in the headspace of such containers during the storage period, when the detection is carried out using common quantitative techniques, such as gas chromatography employing DRAEGER-TUBES® or GASTEC® tubes for headspace measurements. The enclosed containers containing the stabilized compositions are suitably opened periodically and temporarily throughout the storage period, wherein no H₂S is detected within the container, e.g., in the headspace above the stabilized concentrate during any one or more such openings. Thus, the enclosed storage containers may be defined as “substantially enclosed containers” wherein “substantially” here indicates that the containers containing the stabilized concentrates are enclosed during the storage period but are suitably opened periodically and temporarily throughout the storage period.

This feature of the invention is highly advantageous, since as a result of the stabilization of the compounds, no pressure develops in the enclosed containers due to accumulation of H₂S gas; a user opening the enclosed container after a period of storage is not exposed to toxic H₂S gas; and the corrosion inhibitor is not degraded during the storage. Degradation of the corrosion inhibitor leads to loss of active corrosion inhibitor.

The container used to enclose the stabilized concentrate is not particularly limited in terms of materials, shape, or size and is selected by the user for convenience of storing the container during a storage period. In various embodiments the stabilized compositions are stored within a container comprising one or more materials that are stable to aqueous solutions, such as glass, a polyamide, a metal, polyethylene terephthalate (PET), a polystyrene, an acrylonitrile-butadiene-styrene (ABS) terpolymer, or a polyolefin, such as polyethylene, polypropylene, and copolymers thereof including copolymers with α-olefins, such as octene and hexene. The container is suitably in the form of a bottle, jar, carboy, tank, drum, and the like. The containers generally include means to periodically and temporarily open the otherwise enclosed container comprising a stabilized corrosion inhibitor composition of the invention; such means include, but are not limited to, screw caps, valves, snap caps, fitted corks, fitted lids secured by pressure from e.g., clamps, clips, brackets; and the like.

Thus, in embodiments, a stabilized corrosion inhibitor composition comprises, consists essentially of, or consists of an ether diamine compound combined with a sulfur-containing compound. In some embodiments, the stabilized corrosion inhibitor composition is a stabilized concentrate. The stabilized corrosion inhibitor composition is stable for a storage period of about 1 day to about 2 years at a temperature of about 0° C. to about 60° C., as described above, wherein “stable” means that no measurable H₂S is evolved from the stabilized corrosion inhibitor composition during the storage period. In some embodiments, “stable” means that no measurable H₂S is evolved during the storage period and the corrosion inhibitor composition does not substantially degrade or react to form a compound that cannot inhibit corrosion.

In some embodiments, a method of storing the corrosion inhibitor composition comprises, consists essentially of, or consists of combining an ether diamine compound with a sulfur-containing compound to form a stabilized corrosion inhibitor composition, and storing the stabilized corrosion inhibitor composition in an enclosed container for a period of time, wherein substantially no H₂S is formed within the enclosed container. In some such embodiments, no H₂S is detectible within the headspace of the enclosed container. As used herein, “headspace” means the space within the enclosed container that is unoccupied by the stabilized corrosion inhibitor composition. In some embodiments, the headspace comprises air.

The foregoing may be better understood by reference to the following examples, which are intended for illustrative purposes and are not intended to limit the scope of the disclosure or its application in any way.

### EXAMPLES

Various amounts of 2-mercaptoethanol and an ether diamine compound (4,7,10-trioxa-1,13-tridecanediamine) were blended. The blends were then assessed for headspace H₂S and compared with 2-mercaptoethanol by itself after leaving for a week at elevated temperature.

Blends including about 40 grams of 5% w/w mercaptoethanol with varying amounts of the ether diamine compound were prepared in water using 4 oz French square bottles and stored in a temperature-controlled cabinet at about 50° C. After exposure, the H₂S in the headspace was measured using hydrogen sulfide detector tubes from Gastec Corporation.

Under the conditions evaluated, the 2-mercaptoethanol with the ether diamine compound had significantly reduced or non-detectable levels of H₂S in the headspace while the 2-mercaptoethanol by itself had large levels of H₂S detected. The results are shown in Table 1 below.

TABLE 1

| SAMPLE | % (w/w) 2- | % (w/w) ether | H₂S Headspace |
|---|---|---|---|
| ID | mercaptoethanol | diamine | (ppm) |
| 1 | 5 | 0 | >500 |
| 2 | 5 | 0.5 | 40 |
| 3 | 5 | 1 | 20 |
| 4 | 5 | 2 | 15 |
| 5 | 5 | 5 | Not detectable |
| 6 | 5 | 7.5 | Not detectable |
| 7 | 5 | 10 | Not detectable |

In another series of experiments, blends of 2-mercaptoethanol and 4,7,10-trioxa-1,13-tridecanediamine were tested for corrosion performance. Bubble Cell tests were carried out with a carbon steel electrode (C1018 grade). The corrosion rate was assessed electrochemically using linear polarization resistance (LPR) methodology.

The following conditions were used: about 80° C., CO₂ saturated fluids with 3% NaCl brine (100% brine) with continuous CO₂ sparge, atmospheric pressure. A pre-corrosion time (i.e., with no corrosion inhibitor) was carried out for about 2-3 hours before either about 50 ppm COMP 1 (5 wt. % 2-mercaptoethanol in water), 50 ppm COMP 2 (5 wt. % 4,7,10-trioxa-1,13-tridecanediamine in water) or 25 ppm COMP 3 (about 5 wt. % 2-mercaptoethanol and about 5 wt. % 4,7,10-trioxa-1,13-tridecanediamine in water). This equated to about 2.5 ppm total active chemistry being introduced into the test cell. The inhibited corrosion rate at about 15 hours after COMP 1, 2, or 3 injection was noted and a percentage inhibition determined by comparing with the corrosion rate of a carbon steel electrode under otherwise the same conditions in the absence of chemical corrosion inhibitor after the same time of exposure to the corrosive environment.

The results gained are shown in Table 2 below. It can be seen that about 2.5 ppm of COMP 3 (i.e., about 1.25 ppm of 2-mercaptoethanol and about 1.25 ppm 4,7,10-trioxa-1,13-tridecanediamine) resulted in much better corrosion inhibition compared with 2.5 ppm of each of the chemistries when injected individually. Accordingly, Applicant discovered unexpected synergy between certain components of the compositions disclosed herein.

TABLE 2

| | | | | | Amount of | | | |
|---|---|---|---|---|---|---|---|---|
| | | | | | 4,7,10- | | | |
| | | | | | trioxa-1,13- | | | |
| | | | | Amount 2- | tridecanediamine | | | |
| | | | | Mercaptoethanol | (ether diamine) | | Corrosion | |
| | | Amount | | dosed | dosed | Total | Rate After | |
| | Amount 2- | ether | | [based on | [based on | Chemistry | 15 h of Cl | |
| | Mercaptoethanol | diamine | | water phase] | water phase] | Dosed | Injection | % |
| Additive | (wt %) | (wt %) | Dose | (ppm) | (ppm) | (ppm) | (mpy) | Protection |
| Blank | N/A | N/A | N/A | N/A | N/A | N/A | 502 | N/A |
| COMP 1 | 5.0 | 0.0 | 50 | 2.50 | 0.00 | 2.50 | 84 | 83 |
| COMP 2 | 0.0 | 5.0 | 50 | 0.00 | 2.50 | 2.50 | 564 | N/A |
| COMP 3 | 5.0 | 5.0 | 25 | 1.25 | 1.25 | 2.50 | 68 | 86 |

Given 564 mpy of 4,7,10-trioxa-1,13-tridecanediamine is within 15% of the blank (502 mpy), it is interpreted that this chemistry has no effect on corrosion inhibition (either positive or negative). In Table 2, the dosage of the COMP 1, 2, or 3 was in ppm based on the water phase.

All of the compositions and methods disclosed and claimed herein can be made and executed without undue experimentation in light of the present disclosure. While this invention may be embodied in many different forms, there are described in detail herein specific preferred embodiments of the invention. The present disclosure is an exemplification of the principles of the invention and is not intended to limit the invention to the particular embodiments illustrated. In addition, unless expressly stated to the contrary, use of the term “a” is intended to include “at least one” or “one or more.” For example, “a compound” is intended to include “at least one compound” or “one or more compounds.”

Any ranges given either in absolute terms or in approximate terms are intended to encompass both, and any definitions used herein are intended to be clarifying and not limiting. Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard deviation found in their respective testing measurements. Moreover, all ranges disclosed herein are to be understood to encompass any and all subranges (including all fractional and whole values) subsumed therein.

Any composition disclosed herein may comprise, consist of, or consist essentially of any element, component and/or ingredient disclosed herein or any combination of two or more of the elements, components or ingredients disclosed herein.

Any method disclosed herein may comprise, consist of, or consist essentially of any method step disclosed herein or any combination of two or more of the method steps disclosed herein.

The transitional phrase “comprising,” which is synonymous with “including,” “containing,” or “characterized by,” is inclusive or open-ended and does not exclude additional, un-recited elements, components, ingredients and/or method steps.

The transitional phrase “consisting of” excludes any element, component, ingredient, and/or method step not specified in the claim.

The transitional phrase “consisting essentially of” limits the scope of a claim to the specified elements, components, ingredients and/or steps, as well as those that do not materially affect the basic and novel characteristic(s) of the claimed invention.

Unless specified otherwise, all molecular weights referred to herein are weight average molecular weights and all viscosities were measured at 25° C. with neat (not diluted) polymers.

As used herein, the term “about” refers to the cited value being within the errors arising from the standard deviation found in their respective testing measurements, and if those errors cannot be determined, then “about” may refer to, for example, within 5%, 4%, 3%, 2%, or 1% of the cited value.

Furthermore, the invention encompasses any and all possible combinations of some or all of the various embodiments described herein. It should also be understood that various changes and modifications to the presently preferred embodiments described herein will be apparent to those skilled in the art. Such changes and modifications can be made without departing from the spirit and scope of the invention and without diminishing its intended advantages. It is therefore intended that such changes and modifications be covered by the appended claims.

What is claimed is:

1. A method of inhibiting corrosion of a metal surface in contact with a medium, comprising:
adding an effective amount of an ether diamine compound to the medium, and adding an effective amount of a sulfur-containing compound to the medium.

2. The method of claim 1, wherein the ether diamine compound comprises the following formula I: 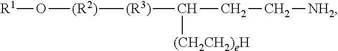
wherein e is 0 or 1;
R¹ is a C₃ to C₂₂ alkyl group;
R² is —(CH₂CH₂O)ₐ—(CH₂CH(CH₃)O)_{b}—(CH₂CH(CH₂CH₃)O)_{c}—;
a, b, and c are independently selected from an integer ranging from 0 to about 30; and
R³ is 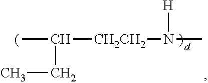
wherein d is 1.

3. The method of claim 1, wherein the ether diamine compound comprises the following formula II: 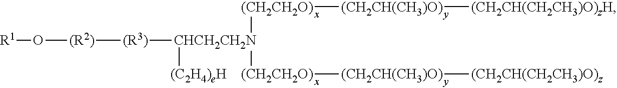
wherein R¹ is a C₃ to C₂₂ alkyl group or a C₆ to C₂₀ aryl group;
R² is —(CH₂CH₂O)ₐ—(CH₂CH(CH₃)O)_{b}—(CH₂CH(CH₂CH₃)O)_{c}—;
a, b, and c are independently selected from an integer ranging from 0 to about 30, with the proviso that a+b+c is from 0 to about 60; and
R³ is 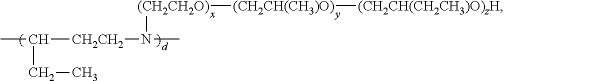
wherein d is 1, e is 0 or 1, and x, y, and z are independently selected from an integer ranging from 0 to about 30 with the proviso that x+y+x is at least 2 but not greater than 60.

4. The method of claim 1, wherein the ether diamine compound comprises the following formula III: 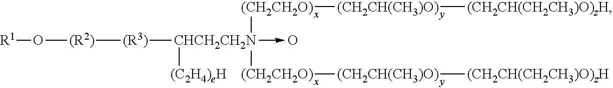
wherein R¹ is a C₃ to C₂₂ alkyl group or a C₆ to C₂₀ aryl group;
R² is —(CH₂CH₂O)ₐ—(CH₂CH(CH₃)O)_{b}—(CH₂CH(CH₂CH₃)O)_{c}—;
a, b, and c are independently selected from an integer ranging from 0 to about 30, with the proviso that a+b+c is from 0 to about 60; and
R³ is 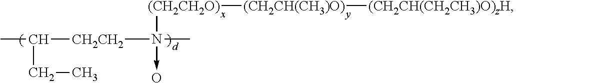
wherein d is 1, e is 0 or 1, and x, y, and z are independently selected from an integer ranging from 0 to about 30 with the proviso that x+y+x is at least 2 but not greater than 60.

5. The method of claim 1, wherein the ether diamine compound comprises the following formula IV: 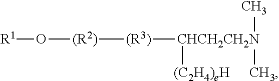
wherein R¹ is a C₃ to C₂₂ alkyl group or a C₆ to C₂₀ aryl group;
R² is —(CH₂CH₂O)ₐ—(CH₂CH(CH₃)O)_{b}—(CH₂CH(CH₂CH₃)O)_{c}—;
a, b, and c are independently selected from an integer ranging from 0 to about 30, with the proviso that a+b+c is from 0 to about 60; and
R³ is 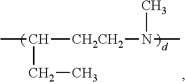
wherein d is 1, and e is 0 or 1.

6. The method of claim 1, wherein the ether diamine compound comprises the following formula V: 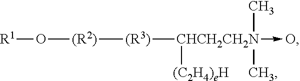
wherein R¹ is a C₃ to C₂₂ alkyl group or a C₆ to C₂₀ aryl group;
R² is —(CH₂CH₂O)ₐ—(CH₂CH(CH₃)O)_{b}—(CH₂CH(CH₂CH₃)O)_{c}—;
a, b, and c are independently selected from an integer ranging from 0 to about 30, with the proviso that a+b+c is from 0 to about 60; and
R³ is 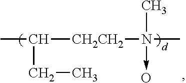
wherein d is 1 and e is 0 or 1.

7. The method of claim 1, wherein the ether diamine compound comprises the following formula VI: 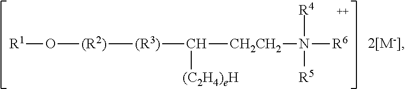
wherein R¹ is a C₃ to C₂₂ alkyl group;
R² is —(CH₂CH₂O)ₐ—(CH₂CH(CH₃)O)_{b}—(CH₂CH(CH₂CH₃)O)_{c}—;
a, b, and c are independently selected from an integer ranging from 0 to about 30;
R³ is 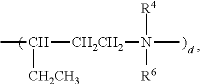
wherein d is 1 and e is 0 or 1;
R⁴ and R⁵ are independently selected from —CH₃ and —(CH₂CH₂O)ₓ—(CH₂CH(CH₃)O)_{y}— (CH₂CH(CH₂CH₃)O)_{z}H;
x, y, and z are independently selected from integers ranging from 0 to about 20, with the proviso that x+y+z is greater than or equal to 3;
R⁶ is selected from —CH₃ or —CH₂—C₆H₅; and
M is an anion.

8. The method of claim 1, wherein the ether diamine compound comprises 4,7,10-trioxa-1,13-tridecanediamine.

9. The method of claim 1, wherein a composition comprises from about 0.5 wt. % to about 99 wt. % of the ether diamine compound.

10. The method of claim 9, wherein the composition comprises from about 0.5 wt. % to about 99 wt. % of the sulfur-containing compound.

11. The method of claim 1, wherein a second composition comprises the sulfur-containing compound in an amount ranging from about 0.5 wt. % to about 99 wt. %.

12. The method of claim 1, wherein the sulfur-containing compound is added before, after, and/or with the ether diamine compound.

13. The method of claim 1, wherein the effective amount of the ether diamine is from about 1 ppm to about 50,000 ppm and/or wherein the effective amount of the sulfur-containing compound is from about 1 ppm to about 50,000 ppm.

14. The method of claim 1, wherein the medium comprises produced water, fresh water, recycled water, salt water, surface water, condensed water, cooling water, injection water, waste water, geothermal waters, sewage water, nuclear cooling water, or any mixture thereof.

15. The method of claim 1, wherein the sulfur-containing compound is selected from the group consisting of a mercaptoethanol, a thiosulfate, thioglycolic acid, and any combination thereof.

16. A corrosion inhibitor composition, comprising:
an ether diamine compound and a sulfur-containing compound.

17. The composition of claim 16, wherein the sulfur-containing compound is selected from the group consisting of a mercaptoethanol, a thiosulfate, thioglycolic acid, and any combination thereof.

18. The composition of claim 16, wherein the ether diamine compound comprises 4,7,10-trioxa-1,13-tridecanediamine.

19. The composition of claim 16, further comprising a medium selected from the group consisting of produced water, fresh water, recycled water, salt water, surface water, condensed water, cooling water, injection water, waste water, geothermal waters, sewage water, nuclear cooling water, and any combination thereof.

20. A method of storing a corrosion inhibitor including a sulfur-containing compound, the method comprising:
combining the sulfur-containing compound with an ether diamine compound to form a stabilized corrosion inhibitor composition, wherein the weight ratio of the sulfur-containing compound to the ether diamine compound is about 1000:1 to about 1:1000; and
storing the stabilized corrosion inhibitor composition in a substantially enclosed container for a period of time, wherein substantially no H₂S is formed within the container during the storing.
